(19) United States
(12) Patent Application Publication
(10) Pub. No.: US 2026/0254142 A1
(43) Pub. Date: Aug. 27, 2026

(54) HIGH VOLTAGE ELECTRICAL CONNECTOR

(71) Applicant: Aptiv Technologies AG, Schaffhausen (CH)

(72) Inventors: Nicholas DURSE, Youngstown, OH (US); Duane BRANTINGHAM, Cortland, OH (US); William LOVITZ, Niles, OH (US); James M. Rainey, Warren, OH (US); Wyatt Lipinsky, Youngstown, OH (US)

(21) Appl. No.: 19/308,609

(22) Filed: Aug. 25, 2025

Related U.S. Application Data
(60) Provisional application No. 63/763,972, filed on Feb. 27, 2025.

(51) Int. Cl. H01R 12/77; H01R 13/04; H01R 13/506; H01R 13/52; H01R 13/6581

(52) U.S. Cl. CPC H01R 12/777; H01R 13/04; H01R 13/506; H01R 13/5202; H01R 13/5216; H01R 13/6581

(57) ABSTRACT

An electrical connector includes a first terminal having a planar first pad for connection to a power conductor of a first flat electrical wire and a first interface for mating with a corresponding first mating terminal. The first pad is arranged substantially perpendicular to the first interface. The electrical connector also includes a second terminal having a planar second pad for connection to a power conductor of a second flat electrical wire and a second interface for mating with a corresponding second mating terminal. The second pad is arranged substantially perpendicular to the second interface.

### CROSS-REFERENCE TO RELATED APPLICATIONS

This application claims the benefit of and priority to U.S. Provisional Application No. 63/763,972, titled “High Voltage Electrical Connector”, filed Feb. 27, 2025, the contents of which are incorporated by reference herein.

### TECHNICAL FIELD

The subject matter disclosed herein relates to electrical connectors, particularly to electrical connectors that are well suited for use with flat wire cables in high voltage applications.

### BACKGROUND

Current high voltage (HV) connectors, such as those used in power conversion applications with battery packs, inverter devices, etc., rely on large gauge cable (e.g., having a cross sectional area of 35 mm² to 150 mm²) or large bus bars to transmit the high electrical current associated with these applications. These high power conductors are heavy and require a lot of copper or aluminum. Bus bars are rigid and difficult to route in vehicle. Large cross section cables can also become quite rigid, even if a stranded wire cable is used.

### SUMMARY

In some aspects, the techniques described herein relate to an electrical connector, including a first terminal having a planar first pad configured to be connected to a power conductor of a first flat electrical wire and a first interface configured to connect to a first corresponding mating terminal. The first pad is arranged substantially perpendicular to the first interface. The electrical connector further including a second terminal having a planar second pad configured to be connected to a power conductor of a second flat electrical wire and a second interface configured to connect to a second corresponding mating terminal. The second pad is arranged substantially perpendicular to the second interface.

In some aspects, the techniques described herein relate to an electrical connector, including a first terminal contained within a first terminal housing, a second terminal contained within a second terminal housing, an outer housing having a cavity configured to receive and retain the first and second terminal housings, and a curable sealant material injected within the cavity configured to further retain the first and second terminal housings within the cavity.

In some aspects, the techniques described herein relate to an electrical connector, including a flat electrical wire having a shield conductor surrounding a power conductor connected to an electrical terminal, an electromagnetic shield surrounding a portion of the electrical terminal, the electromagnetic shield, and a pointed fastening device configured to mechanically and electrically interconnect the shield to the shield conductor by piercing through the shield conductor.

### BRIEF DESCRIPTION OF THE DRAWINGS

FIG. 1 is an isometric view of a shielded flat cable according to some embodiments.

FIGS. 2A and 2B are isometric views of terminals of an electrical connector configured for use with the shielded flat cable of FIG. 1 according to some embodiments.

FIG. 3A is an isometric view of a terminal insulator configured for use with the terminals of FIGS. 2B and 2B according to some embodiments.

FIG. 3B is an isometric view of an inner shield configured for use with the terminals of FIGS. 2B and 2B according to some embodiments.

FIG. 4A is an isometric view of a connector according to some embodiments.

FIG. 4B is an isometric view of a retainer of the electrical connector according to some embodiments.

FIGS. 5A and 5B are isometric views of the terminals of FIGS. 2B and 2B connected to a tab formed by an inner conductor of the shield flat cable according to some embodiments.

FIGS. 6A, 6B, and 6C are isometric views of the terminals of FIGS. 2B and 2B being inserted into a terminal insulator and the subassembly resulting therefrom according to some embodiments.

FIGS. 7A, 7B, and 7C are isometric views of terminal housing subassemblies being attached to one another and the subassembly resulting therefrom according to some embodiments.

FIG. 8 is an alternative isometric view of the subassembly of the subassembly of FIG. 7C according to some embodiments.

FIGS. 9A and 9B are isometric views of the subassembly of FIG. 7C being inserted into the connector housing of FIG. 7B and the subassembly resulting therefrom according to some embodiments.

FIG. 10A is an isometric view of a sealant filling a rear cavity of the connector housing according to some embodiments.

FIG. 10B is an isometric view of the retainer of FIG. 4B attached to the subassembly of FIG. 9B according to some embodiments.

FIGS. 11A and 11B are isometric views of an overmold surrounding the flat cables according to some embodiments.

FIGS. 12A and 12B are isometric views of a piercing shield, FIG. 12C is a side view of the piercing shield, and FIG. 12D is a magnified view of the barb feature according to some embodiments.

FIGS. 13A and 13B are isometric views of a piercing shield with the piercing element attached to a retainer, FIG. 13C is a side view of the barb feature attached to the retainer, and FIG. 13D is a magnified view of the barb feature attached to the retainer according to some embodiments.

FIGS. 14A and 14B are isometric views of a terminal insulator with piercing shield installed, FIG. 14C is a side view of the barb feature in an open position to receive the flat wire, and FIG. 14D is a magnified view of the barb feature in the open position with the flat wire installed according to some embodiments.

FIGS. 15A and 15C are isometric views of a terminal insulator and piercing shield in the closed position retaining the flat wire, FIG. 15B is a cross-sectional view of the piercing shield in the closed position with respect to the flat wire according to some embodiments.

FIG. 15D is a side view of the barb feature in the closed position with the flat wire installed according to some embodiments.

### DETAILED DESCRIPTION

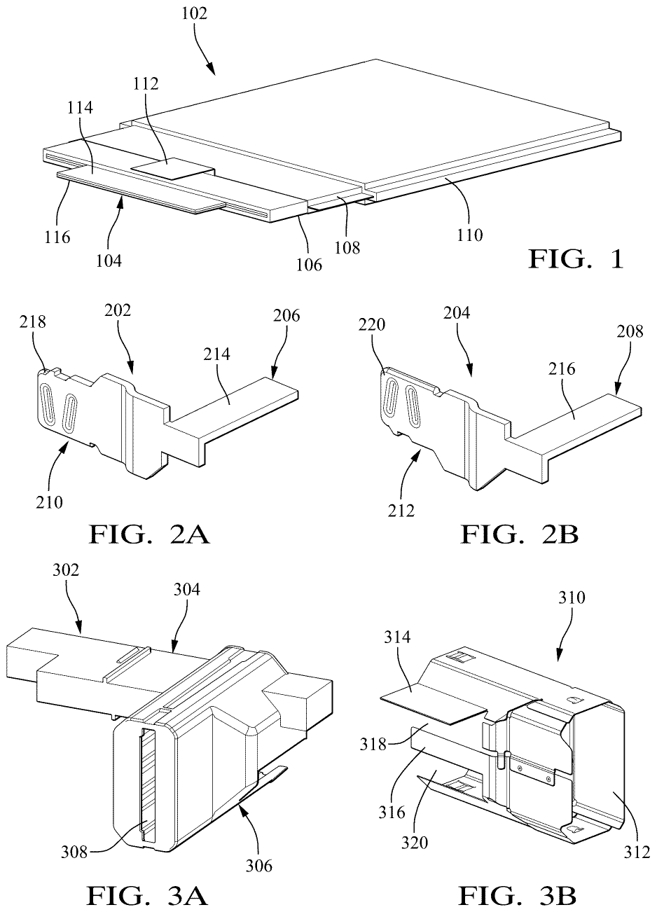

This disclosure describes a direct contact terminal style connector, such as a DCT™ series terminal manufactured by Aptiv PLC, that has been adapted for use with a flat electrical wire 102 as shown in FIG. 1. The flat electrical wire 102 has a power conductor 104 surrounded by an inner insulation layer 106, a shield conductor 108 surrounding the inner insulation layer 106, and an outer insulation layer 110 surrounding the shield conductor 108. Power conductor 104 includes a tab 114 extending beyond the inner insulation layer 106. In some examples, the tab 114 has a width that is less than the width of the power conductor 104 located within the inner insulation layer 106. In some examples, tab 114 includes a planar surface 116 (located on the top or bottom of tab 114) that is utilized for attachment of the power conductor 104 to a terminal (shown in more detail in FIGS. 2A and 2B). In some examples, shield conductor 108 includes a shield tab 112 extending from the shield conductor 108 towards the tab 114 of the power conductor 104.

In some examples, a pair of flat electrical wires 102 are utilized together, with each flat electrical wire 102 being connected to a separate terminal 202, 204 described in more detail with respect to FIGS. 2A and 2B.

Direct contact terminal style connectors are characterized by a direct interface between an electrical terminal and a mated conductor without the need for a mating terminal attached to the mating conductor. This connector design dramatically reduces the mass of the conductor, provides much more flexibility for in-vehicle routing, and eases shipping and handling the connectors and the cable assemblies in which it is utilized.

As shown in FIGS. 2A and 2B, the terminals have distinct first and second terminals 202, 204. The terminals 202, 204 may be utilized together to connect a pair of flat electrical wires 102. The first and second terminals 202, 204 each have a planar pad 206, 208, respectively, and connector interfaces 210, 212. The planar pads 206, 208 each include planar surfaces 214, 216 for connection with the power conductor 104. As shown in FIGS. 2A and 2B, the planar pads 206, 208 are positioned perpendicular to the connector interfaces 210, 212. In one example, the planar pads 206, 208 extend horizontally. In some examples, the terminals 202, 204 are not identical. In particular, the planar pads 206, 208 may be offset from one another along a vertical plane such that the planar pads 206, 208 may overlap with one another when installed.

The connector interfaces 210, 212 each include planar surfaces 218, 220 configured to interact with a connector (not shown). In some examples, the connector interfaces 210, 212 are arranged perpendicular to the planar pads 206, 208. Likewise, the planar surfaces 218, 220 of the connector interfaces 210, 212 are arranged perpendicular to the planar surfaces 214, 216 of the planar pads 206, 208. In some examples, the connector interfaces 210, 212 are blade-style connectors that include features (e.g., protrusions) for interfacing with the connectors (not shown). The configuration of connector interfaces 210, 212 allows the terminals to mate with the standard HV headers originally designed to connect with round wire connectors. In alternative embodiments, the interface portion may be a male pin or female socket shape. This new connector design has the potential to reuse certain components from round wire connectors that mate directly to headers. The terminals can be housed in separate covers that snap together, or in a single molded channel that has walls to separate the terminals for creepage and clearance distance.

FIG. 3A shows a terminal housing 302 configured to hold either the first or second terminals 202, 204 and FIG. 3B shows an inner shield 310 configured to surround either the first or second terminals 202, 204 and the terminal housing 302. Terminal housing 302 includes first portion 304 configured to receive the planar pads 206 or 208 and a second portion 306 configured to receive the connector interface 210 or 212. The second portion 306 includes an aperture 308 that the connector interface 210 or 212 extends through.

Inner shield 310 includes an aperture 312 for receiving the connector interfaces 210 or 212. Inner shield 310 further includes apertures 318, 320 for receiving the first portions 304 associated with the terminal housing 302 (when planar pads 206, 208 overlap horizontally). In some examples, inner shield 310 further includes a tap portion 314 extending away from the inner shield 310 that is configured to connect with the shield tab 112 extending from the shield conductor 108 of the flat wire 102.

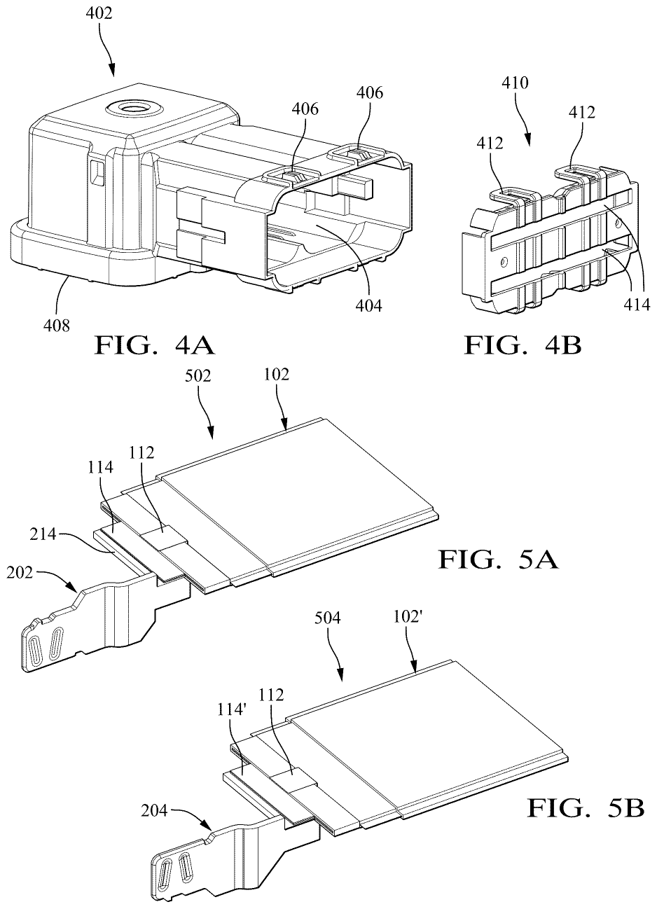

FIGS. 4A and 4B show an insulative connector housing 402 of the connector configured to contain the first and second terminals 202, 204. FIGS. 4A and 4B also shows a retainer 410 configured to be attached to the connector housing 402 and retains the first and second terminals 202, 204 within the connector housing 402. Connector housing 402 includes an aperture 404 for receiving the connector interfaces 210, 212 associated with first and second terminals 202, 204. Connector housing 402 further includes an aperture 408 for receiving a mated connector that interfaces with the connector interfaces 210, 212. Connector housing 402 further includes protrusions or detent elements 406 that interact with latch elements 412 on retainer 410 that snap into place over the detent elements 406 to secure retainer 410 to connector housing 402. Retainer 410 further includes apertures 414 for receiving a pair of flat electrical wires 102.

FIGS. 5A and 5B show the first and second terminals 202, 204 attached to a pair of flat wires 102, 102′ to form first and second sub-assemblies 502, 504, respectively. In particular, the tabs 114 of power conductors 104 are coupled to planar pads 206, 208, with the planar surfaces 214, 216 of each planar pad 206, 208 being brought into contact with planar surface 116 of the power conductor 104. The first and second terminals 202, 204 may be attached to tab 114 by a welding process. As used herein, a “welding process” may refer to, for example, resistance welding, ultrasonic welding, stir welding, spin welding, laser welding, or any other welding process in which the material of the planar pads 206, 208 and the tabs 114 is melted to electrically and mechanically fuse these items together. As used herein, the term “a welding process” may also encompass processes in which the planar pads 206, 208 and the tabs 114 are electrically and mechanically fused by an added material, such as soldering or braising.

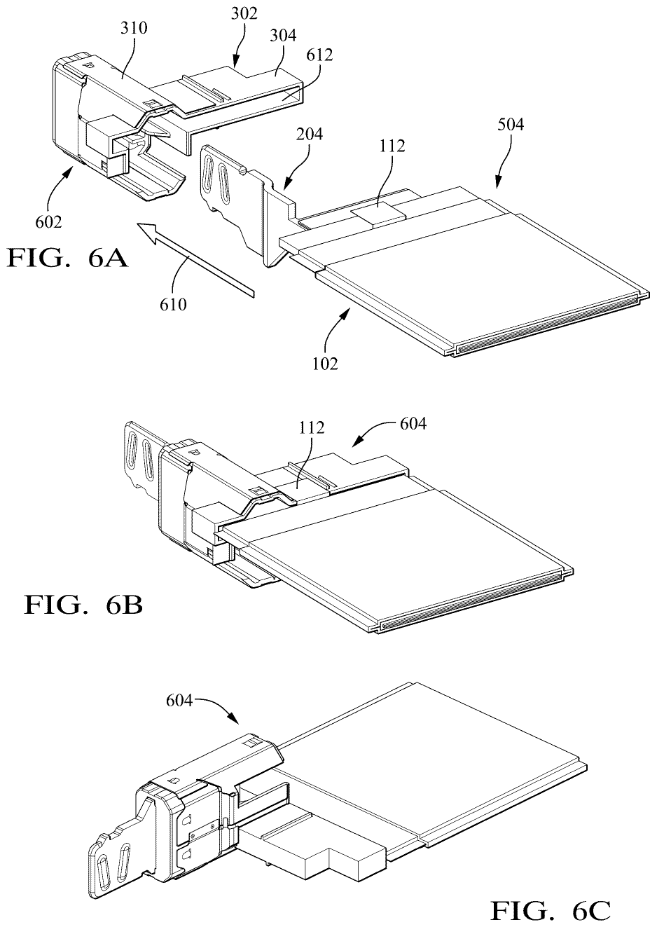

FIGS. 6A, 6B, and 6C show the second subassembly 504 (shown in FIGS. 5A, 5B and including flat wire 102 and second terminal 204 in this example) attached to a third subassembly 602 that includes terminal housing 302 and inner shield 310. The resulting fourth subassembly 606 is shown in the fully assembled state in FIGS. 6B and 6C.

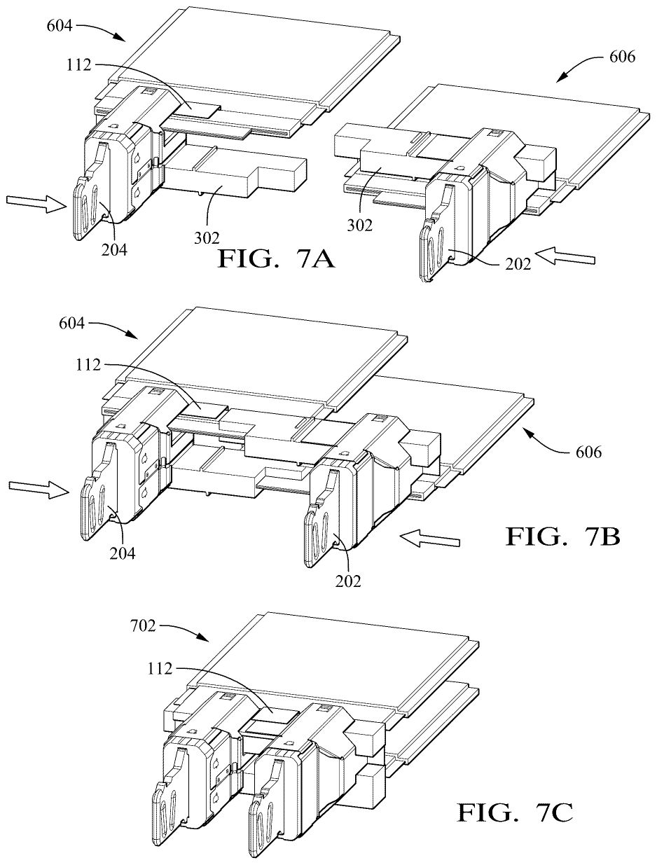

As illustrated by arrow 610 in FIG. 6A, assembly includes moving the second subassembly 504 into contact with the third subassembly 602. In particular, second terminal 204 is engaged within aperture 308 of the terminal housing 302 and extends through aperture 308 such that second terminal 204 protrudes beyond terminal housing 302 of the third subassembly 602. In some examples, engagement of the second subassembly 504 into contact with the third subassembly 602 also includes engagement of the flat wire 102 within the first portion 304 of the terminal housing 302 (in particular, within cavity 612 defined within the second portion 306). However, in other examples, flat wire 102 associated with second subassembly 504 does not come into contact with the cavity 612 defined within the second portion 306 during assembly of the first (or second) subassembly 502, 504 with the third subassembly 602. Rather, the flat wire 102 remains exposed and is positioned within the second portion 306 during assembly of the first and second terminals 202, 204 (shown in FIGS. 7A, 7B, and 7C).

As shown in FIG. 6B, the shield tab 112 is in contact with the inner shield 310. In some embodiments, the shield tab 112 is joined by a welding process to the inner shield 310. In other embodiments, instead of a shield tab 112, the inner shield 310 includes a hinged portion that

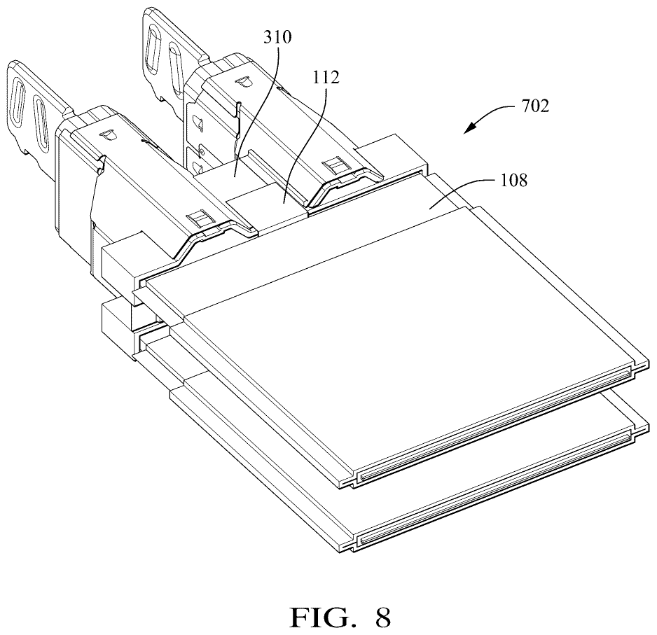

FIGS. 7A, 7B, and 7C show a fourth subassembly 606 containing the first terminal 202 being attached to the third subassembly 604 containing the second terminal 204 to form a fourth subassembly 702, also shown in FIG. 8. The terminal housing 302 includes features that produce audible and/or tactile feedback when the third subassembly 604 is properly joined with the fourth subassembly 606 to successfully verify assembly.

As best shown in FIG. 8, the inner shield 310 is configured to terminate a shield tab 112 of the shield conductor 108 using a welding or soldering process. Alternatively, the inner shield 310 may utilize a clamshell shield design that includes a barb feature configured to puncture the thin shield conductor 108, which acts to make electrical contact between the inner shield 310 and the shield conductor 108 without requiring welding or soldering. An alternative embodiment may include a drain wire that is attached to one end to the shield conductor 108 formed into the flat wire for a soldering operation and on the other end is attached to a connector bolt via a washer which is incorporated into the ground circuit. This alternative embodiment may be suitable where shield performance requirements are less stringent. The entire lead assembly can then be assembled as a cartridge into the back of the connector housing.

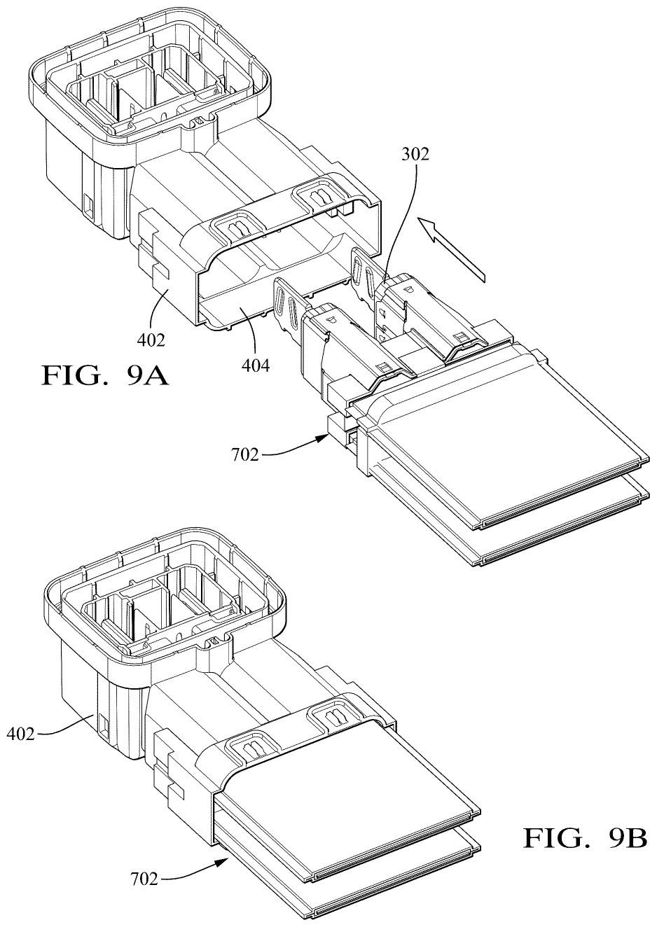

FIGS. 9A and 9B show the fourth subassembly 702 being inserted into the aperture 404 of the connector housing 402. The connector housing 402 and the terminal housing 302 include features that produce audible and/or tactile feedback when the fourth subassembly 702 is properly inserted within the connector housing 402.

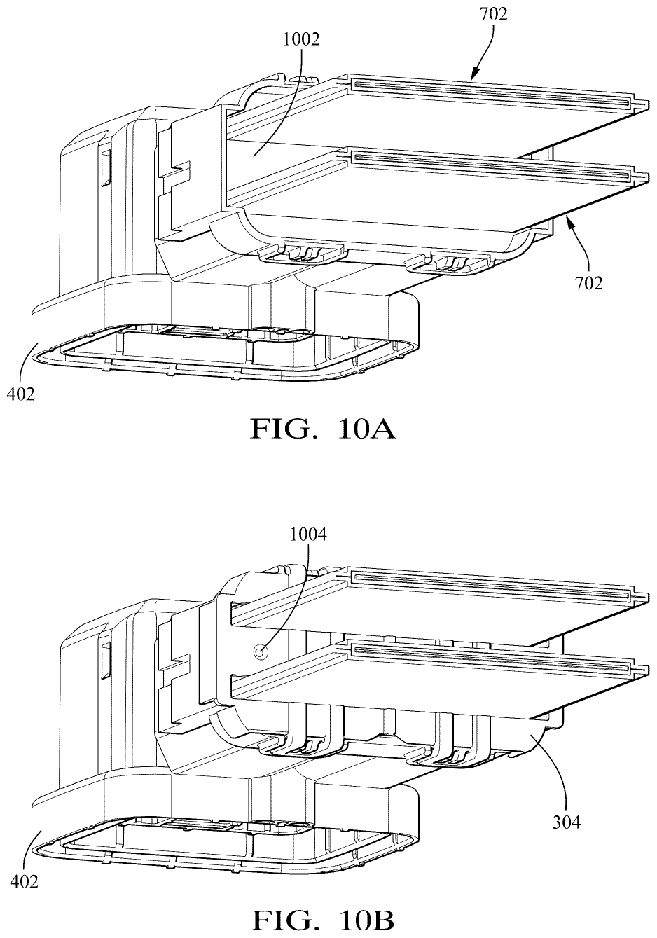

As shown in FIGS. 10A and 10B, the connector housing 402 has provisions for a resilient seal 1002 that separates the flat wire leads and can also act as a molding dam for a potting material when robust environmental sealing is required. The retainer 410 continues this separating feature and has provisions for an injection port 1004 for injecting or otherwise introducing a potting material, i.e., a curable sealant material such as an epoxy resin or silicone rubber, within the cavity and viewing port for visual conformation of the amount and/or distribution of the potting material in the cavity, if required.

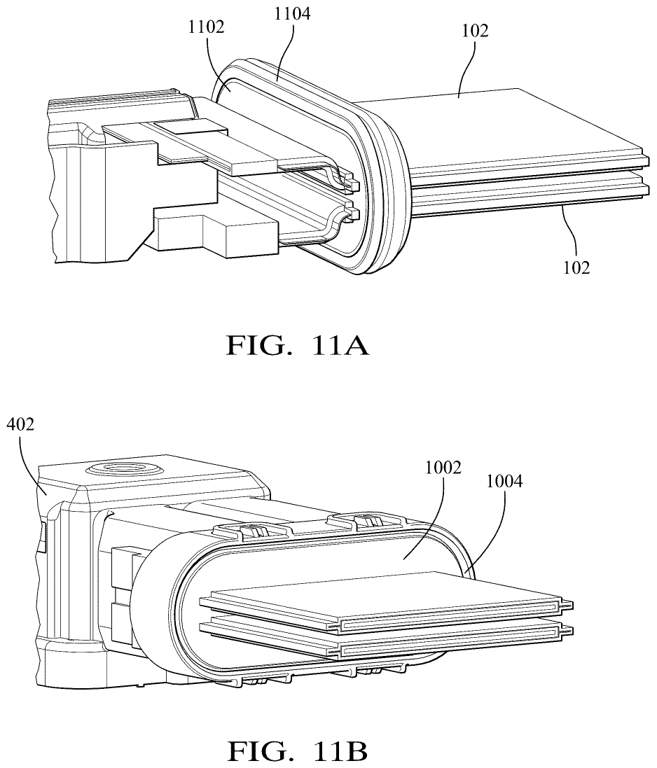

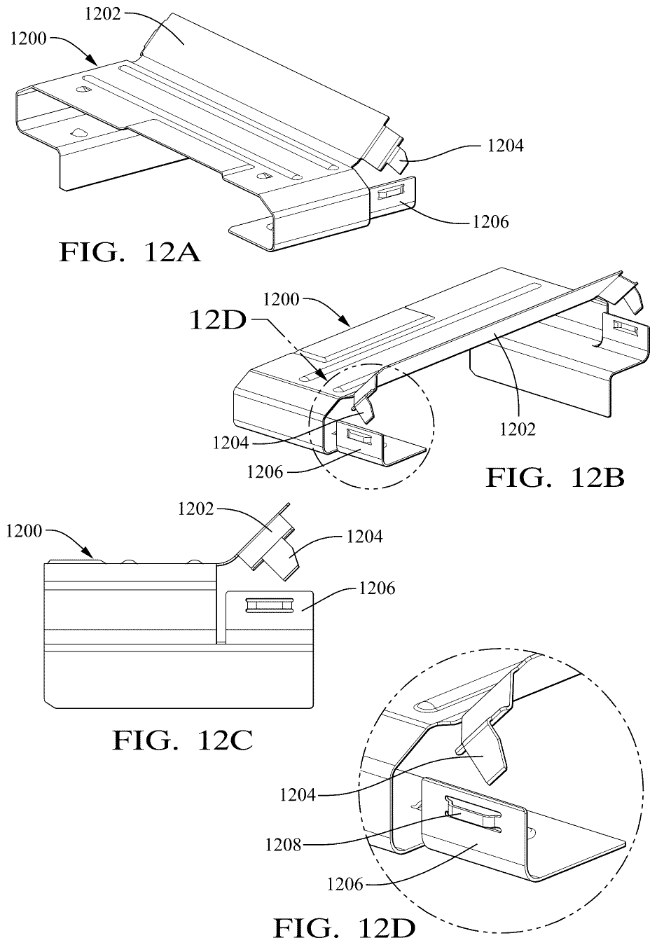

FIGS. 11A and 11B illustrate another embodiment that includes an electrically insulative retainer 1102 formed around the flat electrical wires 102 using a low pressure overmolding process. The retainer 1102 may be formed of a moldable polymeric material, such as polyamides (PA), polyolefins, or thermoplastic elastomers (TPE). The retainer 1102 is surrounded by a peripheral seal 1104 formed of a resilient material, such as silicone rubber which is in compressive contact with the inner walls of the connector housing 402 when robust environmental sealing is required.

While the illustrated examples are a sealed electrical connector, other embodiments may be envisioned that are configured for use with other sealed connector types, such as fiber optic connectors, pneumatic connectors, hydraulic connectors, or a hybrid connectors combining two or more of these technologies.

FIGS. 12A, 12B are isometric views of a piercing shield 1200, FIG. 12C is a side view of the piercing shield 1200, and FIG. 12D is a magnified view of the piercing barb feature 1204. The piercing shield 1200 provides an alternative design for connecting the inner shield 310 to the shield conductor 108 via shield tab 112 (as shown in FIGS. 6B and 7C). Rather than welding shield tab 112 to the inner shield 310, in the embodiment provided in FIGS. 12A-15D the piercing shield 1200 makes electrical contact with the shield conductor 108 via the piercing barb 1204 located on a hinged tab 1202 of the piercing shield 1200. In general, the flat wire 102 is engaged with the terminal housing 302 while the hinged tab 1202 is in the open position. Once engaged, the hinged tab 1202 is moved to a closed position and the piercing barb 1204 is brought into contact with the shield conductor 108 and in fact pierces the shield conductor 108 before being secured by retaining element 1208.

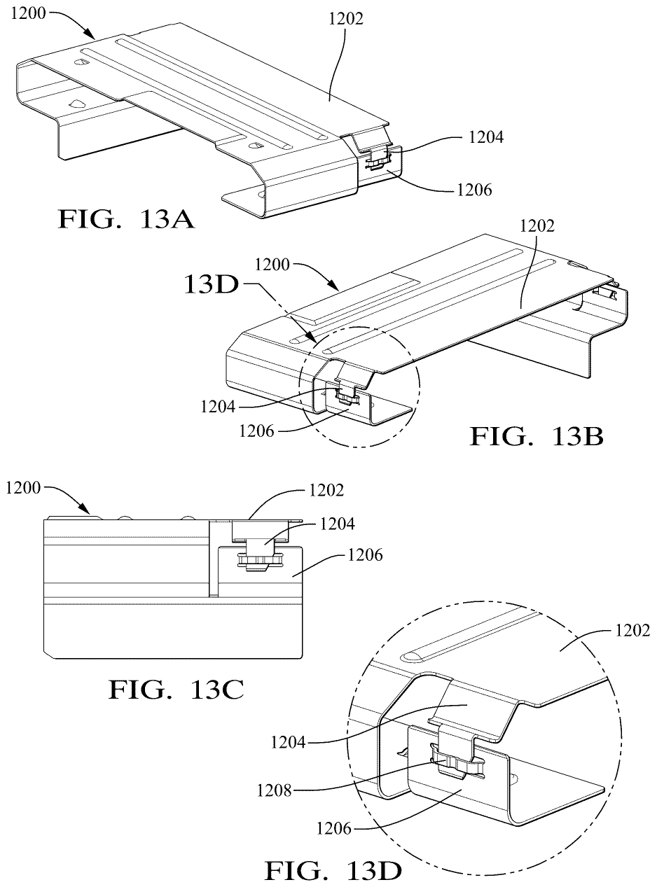

As shown in FIGS. 12A-12C, hinged tab 1202 is connected to the body of piercing shield 1200 and hinges between an open position (shown in FIGS. 12A-12C) and a closed position (shown in FIGS. 13A-13C). At either end of hinged tab 1202 is a piercing barb 1204 configured to pierce the shield conductor 108 associated with the flat wire 102 and engage with retaining element 1208 extending across bottom tab 1206. In the closed position (shown in FIGS. 13A-13D) the bottom tab's piercing barb 1204 is shown engaged with and retained by the retaining element 1208. In some embodiments, retaining element 1208 is crimped to retain the piercing barb 1204 within the retaining element 1208, as shown in FIG. 13D.

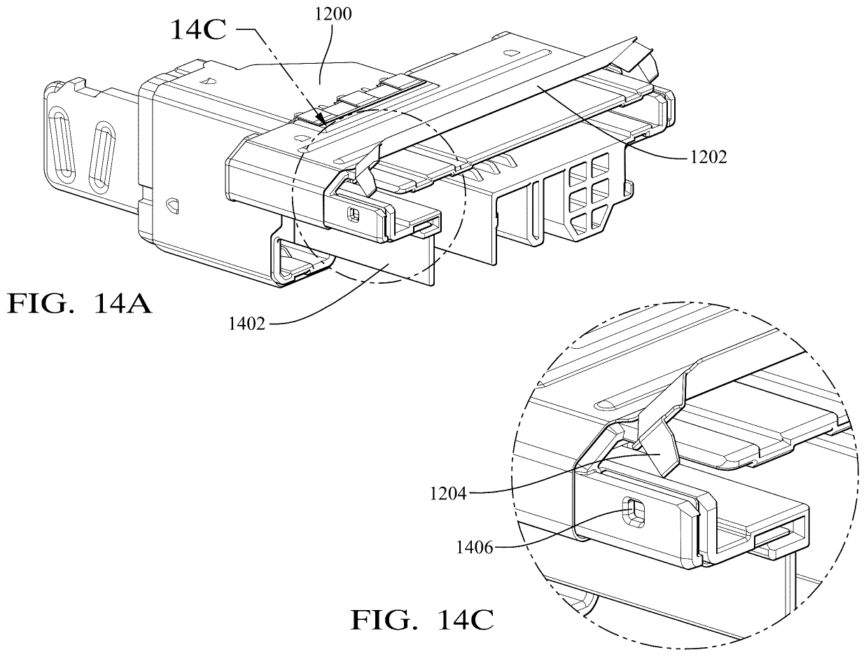

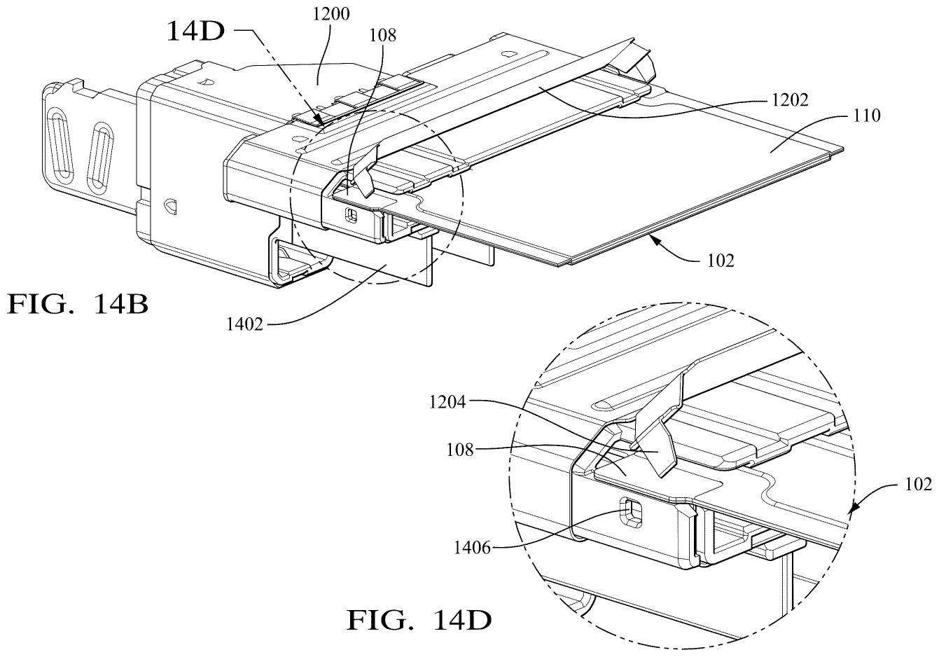

FIGS. 14A and 14C illustrate the piercing shield 1200 installed on terminal housing 1402, with hinged tab 1202 in the open position. FIG. 14B illustrates flat wire 102 installed within terminal housing 1402 during which time the hinged tab 1202 remains in the opened position. FIG. 14D is a magnified view of the piercing barb 1204 positioned above the shield conductor 108 of the flat wire 102 prior to closing of the hinged tab 1202. In this example, the outer insulation layer 110 of the flat wire 102 has been removed to expose a portion of shield conductor 108 in the area adjacent to piercing barb 1204.

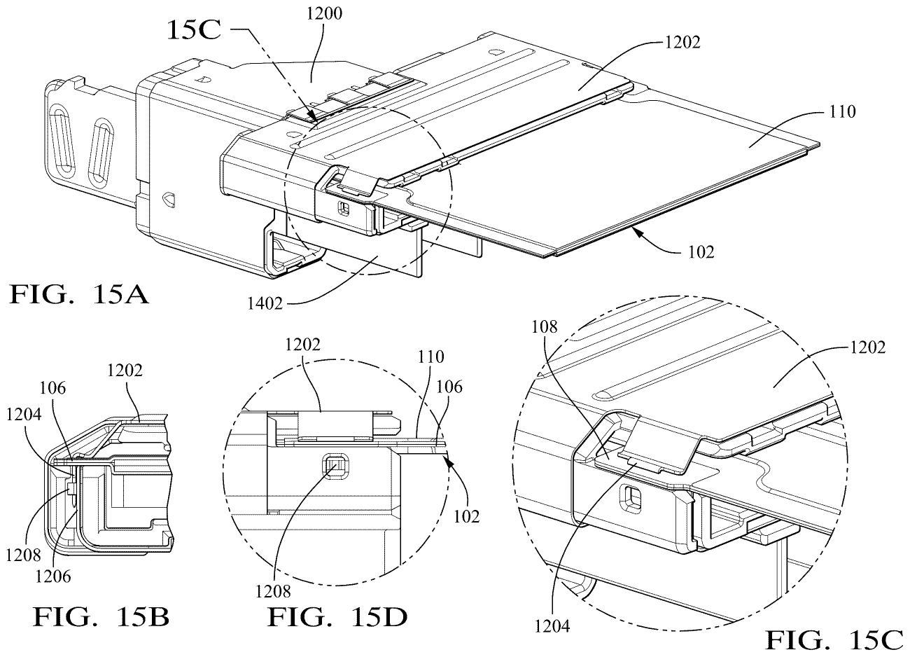

FIGS. 15A and 15C illustrate the hinged tab 1202 in the closed position, such that piercing barb 1204 punctures the shield conductor 108 and forms an electrical contact between piercing shield 1200 and shield conductor 108. In the cross-sectional view shown in FIG. 15B, piercing barb 1204 is shown extending through outer insulation layer 110, inner insulation layer 106, and shield conductor 108 (although shield conductor 108 is hidden behind inner insulation layer 106 in this view). The distal end of piercing barb 1204 is engaged with retaining element 1208, which may be crimped to prevent piercing barb 1204 from disengaging with retaining element 1208. FIG. 15D is a side view of the piercing barb 1204 in the closed position with the flat wire 102 installed.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

### Discussion of Possible Embodiments

The following are non-exclusive and non-limiting descriptions of possible embodiments of the present invention.

In some aspects, the techniques described herein relate to an electrical connector, including a first terminal having a planar first pad configured to be connected to a power conductor of a first flat electrical wire and a first interface configured to connect to a first corresponding mating terminal, the first pad being arranged substantially perpendicular to the first interface; and a second terminal having a planar second pad configured to be connected to a power conductor of a second flat electrical wire and a second interface configured to connect to a second corresponding mating terminal, the second pad being arranged substantially perpendicular to the second interface.

The electrical connector of the preceding paragraph can optionally include, additionally and/or alternatively any, one or more of the following features/steps, configurations and/or additional components.

For example, the first pad may be fused to the first flat electrical wire, and the second pad may be fused to the second flat electrical wire by a welding process.

For example, the first and second pads may be joined to the first and second interfaces at their distal edges.

For example, major planar surfaces of the first and second pads may be arranged substantially parallel to one another.

For example, the first and second interfaces may be planar and wherein major planar surfaces of the first and second interfaces may be arranged substantially parallel to one another.

For example, the electrical connector may further include insulative first and second terminal housings in which the first and second terminals may be received and retained respectively. The first and second terminal housings may have attachment features configured to join the first and second terminal housings as the first and second terminal housings may be moved in a direction parallel to the major planar surfaces of the first and second pads.

For example, the electrical connector may further include electrically conductive first and second shields surrounding portions of the first and second terminal housing and the first and second terminals, respectively. The first and second shields may be configured to be connected to shield conductors of the first and second flat electrical wires.

For example, the first and second shields may further compromise fastening devices configured to interconnect the first and second shields to the shield conductors of the first and second flat electrical wires by piercing through the shield conductors of the first or second flat electrical wires.

For example, the first and second shields may be joined by a welding process to the shield conductors of the first and second flat electrical wires.

For example, the electrical connector may further include an outer housing having a cavity configured to receive and retain the first and second terminal housings.

For example, the electrical connector may further include a curable sealant material injected within the cavity configured to further retain the first and second terminal housings within the cavity.

For example, the electrical connector may further include a resilient seal surrounding a portion of the first and second flat electrical wires and in compressive contact with walls of the cavity, wherein a curable sealant fills a central portion of the seal and is in intimate contact with the portion of the first and second flat electrical wires.

In some aspects, the techniques described herein relate to an electrical connector, including a first terminal contained within a first terminal housing, a second terminal contained within a second terminal housing, an outer housing having a cavity configured to receive and retain the first and second terminal housings, and a curable sealant material injected within the cavity configured to further retain the first and second terminal housings within the cavity.

The electrical connector of the preceding paragraph can optionally include, additionally and/or alternatively any, one or more of the following features/steps, configurations and/or additional components.

For example, the electrical connector may further include a retainer attached to the outer housing and configured to enclose an opening into the cavity.

For example, the retainer may include an injection port through which the curable sealant material may be injected within the cavity.

For example, sidewalls of the cavity may include an exhaust port configured to allow air to escape the cavity as the sealant material is injected within the cavity through the injection port.

For example, the retainer may include openings that are shaped, sized, and arranged to accommodate the first and second flat electrical wires.

For example, inner sidewalls of the cavity may include a depression configured to receive the sealant material and retain the sealant within the cavity once the sealant material is cured.

In some aspects, the techniques described herein relate to an electrical connector, including a flat electrical wire having a shield conductor surrounding a power conductor connected to an electrical terminal, an electromagnetic shield surrounding a portion of the electrical terminal, the electromagnetic shield, and a pointed fastening device configured to mechanically and electrically interconnect the shield to the shield conductor by piercing through the shield conductor.

The electrical connector of the preceding paragraph can optionally include, additionally and/or alternatively any, one or more of the following features/steps, configurations and/or additional components.

For example, the electromagnetic shield may include the pointed fastening device.

1. An electrical connector, comprising:
a first terminal having a planar first pad configured to be connected to a power conductor of a first flat electrical wire and a first interface configured to connect to a first corresponding mating terminal, the first pad being arranged substantially perpendicular to the first interface; and
a second terminal having a planar second pad configured to be connected to a power conductor of a second flat electrical wire and a second interface configured to connect to a second corresponding mating terminal, the second pad being arranged substantially perpendicular to the second interface.

2. The electrical connector in accordance with claim 1, wherein the first pad is fused to the first flat electrical wire, and the second pad is fused to the second flat electrical wire by a welding process.

3. The electrical connector in accordance with claim 1, wherein the first and second pads are joined to the first and second interfaces at their distal edges.

4. The electrical connector in accordance with claim 1, wherein major planar surfaces of the first and second pads are arranged substantially parallel to one another.

5. The electrical connector in accordance with claim 4, wherein the first and second interfaces are planar and wherein major planar surfaces of the first and second interfaces are arranged substantially parallel to one another.

6. The electrical connector in accordance with claim 4, further comprising insulative first and second terminal housings in which the first and second terminals are received and retained respectively, the first and second terminal housings having attachment features configured to join the first and second terminal housings as the first and second terminal housings are moved in a direction parallel to the major planar surfaces of the first and second pads.

7. The electrical connector in accordance with claim 6, further comprising electrically conductive first and second shields surrounding portions of the first and second terminal housing and the first and second terminals, respectively, wherein the first and second shields are configured to be connected to shield conductors of the first and second flat electrical wires.

8. The electrical connector in accordance with claim 7, wherein the first and second shields further compromise fastening devices configured to interconnect the first and second shields to the shield conductors of the first and second flat electrical wires by piercing through the shield conductors of the first or second flat electrical wires.

9. The electrical connector in accordance with claim 7, wherein the first and second shields are joined by a welding process to the shield conductors of the first and second flat electrical wires.

10. The electrical connector in accordance with claim 6, further comprising an outer housing having a cavity configured to receive and retain the first and second terminal housings.

11. The electrical connector in accordance with claim 10, further comprising a curable sealant material injected within the cavity configured to further retain the first and second terminal housings within the cavity.

12. The electrical connector in accordance with claim 10, further comprising a resilient seal surrounding a portion of the first and second flat electrical wires and in compressive contact with walls of the cavity, wherein a curable sealant fills a central portion of the seal and is in intimate contact with the portion of the first and second flat electrical wires.

13. An electrical connector, comprising:
a first terminal contained within a first terminal housing;
a second terminal contained within a second terminal housing;
an outer housing having a cavity configured to receive and retain the first and second terminal housings; and
a curable sealant material injected within the cavity configured to further retain the first and second terminal housings within the cavity.

14. The electrical connector in accordance with claim 13, further comprising a retainer attached to the outer housing and configured to enclose an opening into the cavity.

15. The electrical connector in accordance with claim 14, wherein the retainer comprises an injection port through which the curable sealant material may be injected within the cavity.

16. The electrical connector in accordance with claim 15, wherein sidewalls of the cavity comprises an exhaust port configured to allow air to escape the cavity as the sealant material is injected within the cavity through the injection port.

17. The electrical connector in accordance with claim 14, wherein the retainer comprises openings shaped, sized, and arranged to accommodate first and second flat electrical wires attached to the first and second terminals respectively.

18. The electrical connector in accordance with claim 13, wherein inner sidewalls of the cavity comprises a depression configured to receive the sealant material and retain the sealant within the cavity once the sealant material is cured.

19. An electrical connector, comprising:
a flat electrical wire having a shield conductor surrounding a power conductor connected to an electrical terminal;
an electromagnetic shield surrounding a portion of the electrical terminal, the electromagnetic shield; and
a pointed fastening device configured to mechanically and electrically interconnect the shield to the shield conductor by piercing through the shield conductor.

20. The electrical connector in accordance with claim 19, wherein the electromagnetic shield comprises the pointed fastening device.
